(19) United States
(12) Patent Application Publication
(10) Pub. No.: US 2009/0143520 A1
(43) Pub. Date: Jun. 4, 2009

(54) PARTIALLY AROMATIC POLYAMIDE COMPOSITIONS FOR METAL PLATED ARTICLES

(75) Inventors: ANDRI E. ELIA, Chadds Ford, PA (US); Claudio Pierdomenico, Meyrin Geneva (CH)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY

(21) Appl. No.: 12/274,544

(22) Filed: Nov. 20, 2008

Related U.S. Application Data
(60) Provisional application No. 61/004,857, filed on Nov. 30, 2007.

(51) Int. Cl. C08K 3/26; C08L 77/00; C25D 5/56; B32B 27/06; B05D 3/10

(52) U.S. Cl. 524/425; 524/424; 205/164; 428/458; 427/322

(57) ABSTRACT

Partially aromatic polyamide compositions containing an aliphatic polyamide and an alkaline earth metal carbonate have excellent adhesion to metal coatings which are produced by electroless and/or electrolytic plating. Also described is a process for the electroless and/or electrolytic coating of these compositions. The resulting articles are useful as parts in automotive and industrial applications.

### CROSS-REFERENCE TO RELATED APPLICATION

The present application claims priority to U.S. Provisional Application No. 61/004,857, filed on Nov. 30, 2007, which is incorporated herein by reference in its entirety.

### FIELD OF THE INVENTION

Partially aromatic polyamides compositions particularly suitable for metal plating articles and a process for plating them.

### BACKGROUND OF THE INVENTION

Polymers, such as (thermoplastic) polyamides, are common articles of commerce. Many different items are being made from them. In some instances it is desirable to coat the polyamides with metals. The reasons for coating the polyamide surface with metal vary, but typically include the coating imparts better appearance (for example chrome plating), improved physical properties (for example higher stiffness), and protection of the polyamide from deleterious chemical exposure, or any combination of these or other improvements.

Metal coating is most commonly carried out by surface treating and then “activating” the surface of the polyamide so it may be electrolessly plated, and, optionally, then coating the majority of the metal electrolytically. The surface treatment of the polyamide may involve mechanical and/or chemical “etching” of the surface, so as to allow electroless plating and/or allow and improve the adhesion of the metal layer to the polyamide surface. A typical method of treating the polyamide surface is to use a solution containing sulfuric and chromic (chromium VI) acids, which is often used to surface treat (etch) polyamides, including partially aromatic polyamides (PAPs). See for instance U.S. Pat. No. 5,324,766. However according to the US National Institute for Occupational Safety and Health use of chromium VI is very hazardous to workers, and chromium in general is usually considered a toxic contaminant in the environment.

The polyamide itself may affect what type of surface treatment is needed. For instance aliphatic polyamides such polyamide-6,6 and polyamide-6 may be treated by a variety of methods, but PAPs, in which most or all of the dicarboxylic acid used to form the polyamide is an aromatic dicarboxylic acid, are often more resistant to surface treatment. Being more resistant, adhesion to these PAPs is often lower, so methods of improving the adhesion of metal plating to PAPs are desired.

### SUMMARY OF THE INVENTION

This invention concerns an article comprising, a composition comprising:

(a) at least about 30 weight percent of a partially aromatic polyamide;

(b) about 0.5 to about 15 weight percent of an aliphatic polyamide; and

(c) about 2 to about 20 weight percent of an alkaline earth metal carbonate;

wherein said weight percents are based on the total weight of said composition, and provided that at least part of at least one surface of said composition is metal plated.

This invention also concerns a process for the electroless and/or electroplating of a composition comprising at least about 30 weight percent of a partially aromatic polyamide, wherein the improvement comprises, said composition additionally comprises one or both of about 0.5 to about 15 weight percent of an aliphatic polyamide and/or about 0.5 to about 15 weight percent of a polymeric toughener, and about 2 to about 20 weight percent of an alkaline earth metal carbonate, and wherein said weight percents are based on the total weight of said composition.

### DETAILED DESCRIPTION OF THE INVENTION

Articles of the present invention are made using a composition comprising (a) at least about 30 weight percent of a partially aromatic polyamide; (b) about 0.5 to about 15 weight percent of an aliphatic polyamide; and (c) about 2 to about 20 weight percent of an alkaline earth metal carbonate; wherein said weight percents are based on the total weight of said composition, and provided that at least part of at least one surface of said composition is metal-plated.
Herein certain terms are used and some of them are defined below:
By a “partially aromatic polyamide” (PAP) is meant a polyamide derived in part from one or more aromatic dicarboxylic acids. Polyamides are derived from diamines and dicarboxylic acids. A PAP is derived from one or more aliphatic diamines and one or more dicarboxylic acids, and at least 80 mole percent, preferably at least 90 mole percent and more preferably essentially all of the dicarboxylic acid(s) from which the polyamide is derived from are aromatic dicarboxylic acids. Preferred aromatic dicarboxylic acids are terephthalic acid and isophthalic acid, and terephthalic acid is more preferred.
By an “aliphatic polyamide” (AP) is meant a polyamide derived from one or more aliphatic diamines and one or more dicarboxylic acids, and/or one or more aliphatic lactams, provided that of the total dicarboxylic acid derived units present less than 60 mole percent, more preferably less than 20 mole percent, and especially preferably essentially no units derived from aromatic dicarboxylic acids are present.
By an “aliphatic diamine” is meant a compound in which each of the amino groups is bound to an aliphatic carbon atom. Useful aliphatic diamines include diamines of the formula H₂N(CH₂)ₙNH₂ wherein n is 4 through 12, and 2-methyl-1,5-pentanediamine.
By an “aromatic dicarboxylic acid” is meant a compound in which each of the carboxyl groups is bound to a carbon atom which is part of an aromatic ring. Useful dicarboxylic acids include terephthalic acid, isophthalic acid, 4,4′-biphenyldicarboxylic acid, and 2,6-naphthalenedicarboxylic acid.

Preferred PAPs are those which comprise repeat units derived from one or more of the dicarboxylic acids isophthalic acid, terephthalic acid, adipic acid, and one or more of the diamines H₂N(CH₂)ₙNH₂ wherein n is 4 through 12, and 2-methylpentanediamine. It is to be understood that any combination of these repeat units may be formed to form a preferred PAP.

Preferred APs are those which comprise repeat units derived from one or more dicarboxylic acids, of the formula HO₂C(CH₂)ₘCO₂H wherein m is 2 to 12, isophthalic acid, and terephthalic acid. In an especially preferred dicarboxylic acid is adipic acid (m=4). In these preferred APs comprise the preferred repeat units from diamines are derived from H₂N(CH₂)ₙNH₂ wherein n is 4 through 12, and 2-methylpentanediamine, and the diamine wherein n is 6 is especially preferred. It is to be understood that any combination of these repeat units may be formed to form a preferred AP. Especially preferred specific APs are polyamide-6,6 and polyamide-6 [poly(ε-caprolactam)]. Preferably the amount of AP present is about 0.5 to about 5 weight percent.

The composition(s) used to make the article(s) of the present invention comprise alkaline earth metal (group 2 of periodic table, IUPAC notation) carbonate. Examples of these include magnesium carbonate, calcium carbonate, or barium carbonate. Calcium carbonate is preferred. As is usual with most minerals which are part of thermoplastic polymer compositions, it is preferred that the metal carbonate be in finely divided particulate form, so as to be preferably uniformly distributed in the composition. Carbonates sold for use in thermoplastic compositions are suitable, and typically have an average size range of 1-3 μm. The carbonate used in the present invention may be prepared by any method. For example, calcium carbonate may be prepared by precipitation or by grinding of the naturally occurring mineral. The amount of metal carbonate present is about 2 to about 20 percent, more preferably about 5 to about 15 percent.

In a typical metal plating of a plastic material such as a thermoplastic PAP the surface of the PAP is cleaned and then surface treated. Alternatively, these two steps may be combined, or performed simultaneously. This surface treatment is typically done by using an acidic material such as sulfochromic acid and/or another acidic material such as hydrochloric acid or sulfuric acid. Then the surface is treated with a “catalyst”, typically a palladium compound, and then the electroless plating solution which deposits a layer of metal such as nickel or copper onto the surface of the PAP. This may be the end of the process, or if a thicker and/or different metal layer is desired, the surface may be electroplated in the usual manner. If the PAP composition is electrically conductive then electroless plating is may not be needed, and only the electroplating is done.

Any metal may be used in the composition of the articles of the present invention, so long as it may be electroplated. Useful metals include copper, nickel, cobalt, iron, and zinc. Alloys of these metals such as nickel-iron may also be plated. The resulting electroplated metal layer may have an average metal grain (crystallite) size in the range of 1 nm to 10,000 nm. A preferred average grain size is 1 to 200 nm, more preferably 1 to 100 nm. The total thickness of the coated metals is preferably about 1 μm to about 200 μm, more preferably about 1 μm to about 100 μm.

Useful APs include polyamide-6,6, polyamide-6, and a copolyamide of adipic acid, 1,6-hexanediamine and terephthalic acid in which terephthalic acid is less than 60 mole percent of the dicarboxylic acid derived units present. They may be of any molecular weight, from relatively low to high molecular weights. The composition comprises about 0.5 to about 15 weight percent, preferably about 1.0 to about 5.0 weight percent of the AP.

It is preferred if at least about 40 weight percent of the PAP is present in the composition. It is also preferred if the PAP has a glass transition temperature of about 70° C. or more, more preferably about 100° C. or more, and especially preferably at least about 135° C. or more.

Herein melting points and glass transition temperatures are measured using ASTM Method ASTM D3418-82. The melting point is taken as the peak of the melting endotherm, and the glass transition temperature is taken at the transition midpoint.

The PAP composition to be metal plated may also contain other materials normally found in thermoplastic PAP compositions in the usual amounts such as (note—classification of some of these specific materials may be somewhat arbitrary and sometimes these materials may fulfill more than one function): reinforcing agents such as glass fiber, carbon fiber, aramid fiber, milled glass, and wollastonite; fillers such as clay, mica, carbon black, silica, and other silicate minerals; flame retardants; pigments; dyes; stabilizers (optical and/or thermal); lubricants and/or mold release; tougheners including polymeric tougheners, other polymers such as polyesters and amorphous polyamides, although it is preferred that just the PAP and PA and/or toughener be the only polymers present. Tougheners are a preferred form of polymeric constituent. Preferred materials are reinforcing agents especially glass fiber and carbon fiber. It is to be understood that more than one of each type of these materials may be present, and that more than one type of the above materials may also be present.

The PAP compositions may be made by typical melt mixing techniques used to make thermoplastic compositions, such as mixing in a single or twin screw extruder or in a kneader. Oftentimes after melt mixing the composition will be formed into pellets or granules for later formation into shaped parts. Shaped parts may be formed by typical melt forming methods used for thermoplastics, such as injection molding, extrusion, blow molding, thermoforming, rotational molding, etc.

The present PAP composition gives improved adhesion of the metal coating to that composition. The combination of AP and alkaline earth carbonate usually gives better adhesion than either alone.

Metal plated parts of the PAP composition are useful as automotive parts (including under-the-hoods parts and/or parts that are load bearing and/or must resist deflection), industrial parts, electronic parts including handheld devices, cell phones, notebook computers, etc., having improved properties as mentioned above. The improved adhesion also results in better thermal cycling properties, that is the part is better able to stand thermal cycling without breakage and/or separation of the metal layer.

Herein adhesion means adhesion measured by Zwick® (or equivalent device) Z005 tensile tester with a load cell of 2.5 kN using ISO test Method 34-1. A plaque of the PAP composition is electroplated with 20-25 μm of metal (copper for instance) is fixed on a sliding table which is attached to one end of the tensile tester. Two parallel cuts 1 cm apart were made into the metal surface so that a band of metal on the PAP surface 1 cm wide is created. The table slide in a direction parallel to the cuts. The 1 cm wide copper strip is attached to the other end of the machine, and the metal strip is peeled (at a right angle) at a test speed of 50 mm/min (temperature 23° C., 50% RH). The adhesive strength is then calculated.

In the Examples the following materials are used:
Filler 1—Calcium Carbonate, Super-Pflex®200 available from Specialty Mineral Inc., New York, N.Y. 10174, USA.
Filler 2—A calcined, aminosilane coated kaolin, Polarite® 102A, available from Imerys Co., Paris France.
GF—Chopped (nominal length 3.2 mm) glass fiber, PPG® 3660, available from PPG Industries, Pittsburgh, Pa. 15272, USA.
Polymer A—a PAP made from terephthalic acid, 50 mole percent (of the total diamine present) of 1,6-hexanediamine, and 50 mole percent of 2-methyl-1,5-pentanediamine.
Polymer B—a PA, polyamide-6, Durethan B29 available from Lanxess AG, 51369 Leverkusen, Germany.
Polymer C—a PA, polyamide-6,6, Zytel® 101 available from E.I. DuPont de Nemours & Co., Inc. Wilmington, Del. 19899 USA.
Polymer D—a PA, lower molecular weight polyamide-6,6, Elvamid® 8061 available from E.I. DuPont de Nemours & Co., Inc. Wilmington, Del. 19899 USA.

### EXAMPLES 1-3 AND COMPARATIVE EXAMPLES A-B

Various polyamide compositions were made by mixing the ingredients in 30 mm Werner & Pfleiderer twin screw extruder. The polyamides were fed to the rear section, the glass fiber and filler(s) being fed downstream into the molten polyamide. The barrels were maintained at a nominal temperature of 300° C. Upon exiting the extruder through a strand die the compositions were pelletized. Subsequently the polyamide compositions were injection molded into 7.62 cm×12.70 cm×0.32 cm plaques. Injection molding conditions were drying at 100° C. for 6-8 h in dehumidified air, melt temperature 320-330° C., and mold temperature 140-160° C.

The steps to prepare, activate and plate the surfaces of the plaques are outlined in Table 1.

TABLE 1

| Step | | | Temp. | Time, |
|---|---|---|---|---|
| No. | Bath Type | Additives^{a} | ° C.^{b} | min. |
| 1 | Etching | Sulfochromic acid | 50-80 | 5-20 |
| 2 | Rinse | | | 0.5 twice |
| 3 | Static Rinse | | | 1 |
| 4 | Rinse | | | 1 |
| 5 | Neutralization | Neutraliser PM955^{c} | 55 | 2-5 |
| 6 | Rinse | | | 1 |
| 7 | GRZ etch | | | 3-5 |
| 8 | Rinse | | | 1 |
| 9 | Pre-dip | 10% HCl (v/v) | | 0.5 |
| 10 | Activator | Conductron ® DP (35 ppm | 30 | 1-10 |
| | | Pd)^{c} | | |
| 11 | Rinse | | | 2 |
| 12 | Accelerator | Accelerator PM964^{c} | 45 | 2-10 |
| 13 | Rinse | | | 1 |
| 14 | Chemical Ni | PM 980 R&S^{c} | 30 | 10-30 |
| | PM | | | |
| 15 | Rinse | | | 1 |
| 16 | Galvanic Cu | CuSO₄ | | 40 |
| 17 | Rinse | | | 1 |

^{a}If no additive listed, water used.
^{b}If no temperature listed, room temperature used.
^{c}This material available from Rohm &Haas Electronic Materials Europe, Coventry CV3 2RQ, Great Britain

Details of the compositions and adhesion of the metal layers are given in Table 2. All parts shown are parts by weight.

TABLE 2

| | Example | | | | |
|---|---|---|---|---|---|
| | 1 | 2 | 3 | A | B |
| Polymer A | 57.3 | 57.3 | 57.3 | 59.3 | 59.3 |
| Polymer B | 2 | | | | |
| Polymer C | | 2 | | | |
| Polymer D | | | 2 | | |
| Filler 1 | 10 | 10 | 10 | 10 | |
| Filler 2 | | | | | 10 |
| GF | 30 | 30 | 30 | 30 | 30 |
| Peel adhesion, | 7.6 | 7.8 | 8.4 | 6.7 | 3.0 |
| N/cm | | | | | |

What is claimed is:

1. An article comprising, a composition comprising:
(a) at least about 30 weight percent of a partially aromatic polyamide;
(b) one or both of about 0.5 to about 15 weight percent of an aliphatic polyamide and/or about 0.5 to about 10 weight percent of a polymeric toughener; and
(c) about 2 to about 20 weight percent of an alkaline earth metal carbonate;
wherein said weight percents are based on the total weight of said composition, and provided that at least part of at least one surface of said composition is metal-plated.

2. The article as recited in claim 1 wherein said aliphatic polyamide is present.

3. The article as recited in claim 2 wherein said aliphatic polyamide is polyamide-6,6 or polyamide-6.

4. The article as recited in claim 1 wherein said partially aromatic polyamide comprises repeat units derived from one or more of isophthalic acid, terephthalic acid, adipic acid, H₂N(CH₂)ₙNH₂ wherein n is 4 through 12, and 2-methylpentanediamine.

5. The article as recited in claim 1 wherein said alkaline earth carbonate is calcium carbonate.

6. The article as recited in claim 1 wherein said alkaline earth carbonate is about 5 to about 15 weight percent of said composition.

7. The article as recited in claim 1 wherein said partially aromatic polyamide has a glass transition temperature of about 100° C. or more.

8. The article as recited in claim 1 wherein said metal plating is one or more of copper, zinc, nickel, cobalt, and iron, and alloys thereof.

9. The article as recited in claim 1 wherein said metal plating is 1 μm to about 200 μm thick.

10. The article as recited in claim 1 wherein.

11. A process for the electroless plating and/or electroplating, with one or more metals, of a composition comprising at least about 30 weight percent of a partially aromatic polyamide, wherein the improvement comprises, said composition additionally comprises one or both of about 0.5 to about 15 weight percent of an aliphatic polyamide and/or about 0.5 to about 10 weight percent of a polymeric toughener, and about 2 to about 20 weight percent of an alkaline earth metal carbonate, and wherein said weight percents are based on the total weight of said composition.

12. The process are recited in claim 11 wherein said aliphatic polyamide is present.

13. The process as recited in claim 12 wherein said aliphatic polyamide is polyamide-6,6 or polyamide-6.

14. The process as recited in claim 11 wherein said partially aromatic polyamide comprises repeat units derived from one or more of isophthalic acid, terephthalic acid, adipic acid, H₂N(CH₂)ₙNH₂ wherein n is 4 through 12, and 2-methylpentanediamine.

15. The process as recited in claim 11 wherein said alkaline earth carbonate is calcium carbonate.

16. The process as recited in claim 11 wherein said alkaline earth carbonate is about 5 to about 15 weight percent of said composition.

17. The process as recited in claim 11 wherein said partially aromatic polyamide has a glass transition temperature of about 100° C. or more.

18. The process as recited in claim 11 wherein said composition is surface treated with an acidic material before said electroless plating and/or electroplating of said composition.

19. The process as recited in claim 18 wherein said acidic material is sulfochromic acid.
